(19) United States
(12) Patent Application Publication
(10) Pub. No.: US 2011/0241375 A1
(43) Pub. Date: Oct. 6, 2011

(54) FOLDING TOP DRIVE ASSEMBLY AND CONVERTIBLE VEHICLE

(75) Inventor: Matthias Rösler, Stuttgart (DE)

(73) Assignee: MAGNA CAR TOP SYSTEMS GMBH, Bietigheim-Bissingen (DE)

(21) Appl. No.: 13/070,853

(22) Filed: Mar. 24, 2011

(30) Foreign Application Priority Data
Mar. 26, 2010 (DE) 10 2010 013 009.5

(51) Int. Cl. B60J 7/12

(52) U.S. Cl. 296/107.12

(57) ABSTRACT

A folding top drive assembly for adjusting a folding top with a fabric cover of a convertible vehicle between closed and opened positions includes a tensioning stay and a landau mechanism. The tensioning stay stretches the fabric cover when the folding top is closed. The landau mechanism supports the tensioning stay to a roof frame component when the folding top is closed. The landau mechanism includes upper and lower landau bars and a coupling element. The upper landau bar is hinged at its forward end to the roof frame component. The lower landau bar is hinged at its rearward end to the tensioning stay. The upper landau bar is hinged at its rearward end to the coupling element and the lower landau bar is hinged at its forward end to the coupling element. The landau bars are hinged at a distance from one another to the coupling element.

### CROSS-REFERENCE TO RELATED APPLICATIONS

This application claims foreign priority benefits under 35 U.S.C. §119(a)-(d) to DE 10 2010 013 009.5, filed Mar. 26, 2010, which is hereby incorporated by reference in its entirety.

### TECHNICAL FIELD

The present invention relates to a folding top drive assembly for adjusting a folding top of a convertible vehicle between closed and opened positions.

### BACKGROUND

EP 0 749 859 B1 (corresponds to U.S. Pat. No. 5,816,644) describes a folding top drive assembly for adjusting a folding top having a fabric cover (i.e., a collapsible roof) between closed and opened positions relative to the body of a vehicle. The folding top drive assembly includes a tensioning stay for stretching the fabric cover of the folding top when the folding top is in the closed position. For this purpose, the tensioning stay is attached to a rear end of the fabric cover. In order to be able to hold the clamp securely in the tensioned position even at high vehicle speeds, the folding top drive assembly includes a landau control bar mechanism for bracing the tensioning stay on a roof frame component when the folding top is in the closed position. The landau control bar mechanism includes an upper landau bar and a lower landau bar. The upper landau bar is hinged by its upper end to the roof frame component. The lower landau bar is hinged to the tensioning stay by its lower end. As in a typical folding top drive assembly, the upper landau bar is hinged by its lower end to the upper end of the lower landau bar such that a two-part landau control bar mechanism is obtained.

U.S. Pat. Nos. 6,966,599 and 5,042,868 describe folding top drive assemblies having a two-part landau control bar mechanism.

In some convertibles, it is desirable to form the folded roof so that it is as flat as possible in the rear region to thereby improve visibility and/or air resistance. In order to securely position the tensioning stay in its tensioned stored position for a flat folded roof, the landau bars have to be relatively long. However, long landau bars hinder or disturb the kinematics of the folding top drive assembly. Long landau bars are also difficult to lower into a folding top bin or storage compartment of the vehicle when the folding top is moved to its opened position.

### SUMMARY

An object of the present invention includes a folding top drive assembly for moving a folding top of a convertible vehicle between closed and opened positions in which the folding top drive assembly is configured to enable the rear region of the folding top to have a relatively flat shape while the folding top is in the closed position.

In carrying out the above object and other objects, the present invention provides an assembly for moving a folding top having a fabric cover between a closed position and an opened position. The assembly includes a tensioning stay and a landau control bar mechanism. The tensioning stay is attachable to the fabric cover of the folding top. The landau control bar mechanism has an upper landau bar, a lower landau bar, and a coupling element. The landau control bar mechanism is configured to support the tensioning stay on a roof frame component when the folding top is in the closed position to enable the tensioning stay to stretch the fabric cover when the folding top is in the closed position. The upper landau bar is hinged at a forward end on the roof frame component and the lower landau bar is hinged at a rearward end on the tensioning stay. The upper landau bar is hinged at a rearward end on the coupling element and the lower landau bar is hinged at a forward end on the coupling element. The rearward end of the upper landau bar and the forward end of the lower landau bar are hinged on the coupling element at a distance from one another.

Also, in carrying out the above object and other objects, the present invention provides a convertible vehicle having a folding top and a folding top drive assembly. The folding top includes a fabric cover. The folding top drive assembly is configured to move the folding top between a closed position in which the folding top covers a passenger compartment of the vehicle and an opened position in which the folding top is stored in a storage compartment of the vehicle. The folding top drive assembly includes a tensioning stay attached to the fabric cover of the folding top and a landau control bar mechanism configured to support the tensioning stay on a roof frame component when the folding top is in the closed position to enable the tensioning stay to stretch the fabric cover when the folding top is in the closed position. The landau control bar mechanism includes an upper landau bar, a lower landau bar, and a coupling element. The upper landau bar is hinged at a forward end on the roof frame component and the lower landau bar is hinged at a rearward end on the tensioning stay. The upper landau bar is hinged at a rearward end on the coupling element and the lower landau bar is hinged at a forward end on the coupling element. The rearward end of the upper landau bar and the forward end of the lower landau bar are hinged on the coupling element at a distance from one another.

Embodiments of the present invention provide a folding top drive assembly for adjusting or moving a folding top with a fabric cover (i.e., a collapsible roof with a fabric cover) of a convertible vehicle between a closed position in which the folding top covers the passenger compartment of the vehicle and an opened position in which the folding top is rearwardly lowered into a storage compartment of the vehicle. The folding top drive assembly includes a tensioning stay and at least one landau control bar mechanism. The tensioning stay is attached to a rear end of the fabric cover of the folding top and is configured to stretch the fabric cover when the folding top is in the closed position. The landau control bar mechanism is configured to support the tensioning stay to a roof frame component when the folding top is in the closed position. The landau control bar mechanism includes an upper landau bar and a lower landau bar. The upper landau bar is hinged at its upper end to the roof frame component. The lower landau bar is hinged at its lower end to the tensioning stay. The landau control bar mechanism further includes a coupling element. The upper landau bar is hinged at its lower end to the coupling element and the lower landau bar is hinged at its upper end to the coupling element. The upper and lower landau bars are hinged at a distance from one another to the coupling element. As a result of the existence of the coupling element and the hinging of the upper and lower landau bars thereto, the folding top exhibits an especially flat rear region when the folding top is in the closed position.

A folding top drive assembly in accordance with embodiments of the present invention is generally based on the concept that the two landau bars are not connected directly to one another but are connected indirectly to one another via the coupling element. In particular, the lower end of the upper landau bar and the upper end of the lower landau bar are hinged to the coupling element and are separated from one another. This construction leads to a three-element landau control bar mechanism which includes the two landau bars and the coupling element which connects the landau bars together.

The landau bars of a three-element landau control bar mechanism of a folding top drive assembly in accordance with embodiments of the present invention can each be made shorter than the landau bars of a typical two-element landau control bar mechanism (i.e., a landau control bar mechanism having only the upper and lower landau bars and lacking the coupling element) for the same supported length of the landau control bar mechanism. This simplifies the kinematics of the folding top drive assembly and the lowering of the landau control bar mechanism into the storage compartment of the vehicle when the folding top is in the opened position. An especially flat shape can thus be achieved for the rear region of the folding top when the folding top is in the closed position.

According to an embodiment of the present invention, the coupling element is arranged in such a manner in the landau control bar mechanism that the coupling element pivots during the lowering of the tensioning stay into its tensioned position stretching the fabric cover when the folding top is in the closed position. As a result of the coupling element pivoting, an interval between the pivot point increases between the upper landau bar and roof frame component and the pivot point between the lower landau bar and the tensioning stay. The overall length can thereby be varied by pivoting the coupling element, and with it the support length that can be achieved by the landau control bar mechanism. A maximum length for the landau control bar mechanism can be achieved for the closed folding top. The coupling element can be pivoted to such an extent when the folding top is in the opened position that the landau bars and the coupling element can simply be lowered into the folding top bin of the vehicle.

According to an embodiment of the present invention, the landau control bar mechanism includes a control arm. The control arm is hinged to a roof frame component at its lower end and is hinged to the coupling element at a distance from the hinge position of the two landau bars on the side of the coupling element. With the aid of the control arm, the landau control bar mechanism is stabilized in the region of the coupling element by the support on the roof frame component and is guided with respect to the desired kinematic path.

According to an embodiment of the present invention, the folding top drive assembly further includes an actuator or an actuating drive such as in the form of a piston-cylinder mechanism. One end of the actuator is hinged to a roof frame component and the other end of the actuator is hinged directly or indirectly to the coupling element. The coupling element, which is provided in a three-element landau control bar mechanism of a folding top drive assembly in accordance with embodiments of the present invention, thereby takes on an additional functionality since the adjustment forces for actuating the landau control bar mechanism can be introduced through the coupling element.

According to an embodiment of the present invention, the actuator is hinged indirectly to the coupling element through a lever mechanism having first and second levers. The first lever is hinged to the coupling element and to an end of the actuator. The second lever is hinged to the rear end of the upper landau bar, the rear end of the upper landau bar and the coupling element, and the end of the actuator. As such, the actuator is hinged in particular in the region of the hinge position formed between the two levers of the lever mechanism. A relatively complex kinematic mechanism can be achieved by the indirect coupling between the actuator and the coupling element that enables a compact folding together of the landau control bar mechanism for storage in the storage compartment of the vehicle if space is limited.

The functionality of the coupling element can be further augmented according to another embodiment of the present invention by attachment of a corner bow to the coupling element. The corner bow can be arranged to support the fabric cover in the rear region of the folding top. The corner bow can optionally be hinged in the vicinity of the hinge position between the coupling element and the lower landau bar on the coupling element.

It is to be understood that the aforementioned and subsequently described features are not only useable in the combinations presented but are also useable in other combinations or separately without falling outside of the framework of the present invention.

The above features, and other features and advantages of the present invention are readily apparent from the following detailed description thereof when taken in connection with the accompanying drawings.

### BRIEF DESCRIPTION OF THE DRAWINGS

FIG. 1 illustrates a side view of a folding top drive assembly for adjusting a folding top of a convertible vehicle in accordance with an embodiment of the present invention in which the folding top is in a closed position;

FIG. 2 illustrates a side view of the folding top drive assembly in which the folding top is in a position between the closed position and an intermediate position shown in FIG. 3;

FIG. 3 illustrates a side view of the folding top drive assembly in which the folding top is in the intermediate position;

FIG. 4 illustrates a side view of the folding top drive assembly in which the folding top is in a position between the intermediate position and an opened position; and

FIG. 5 illustrates a side view of the folding top drive assembly in which the folding top is in the opened position.

### DETAILED DESCRIPTION

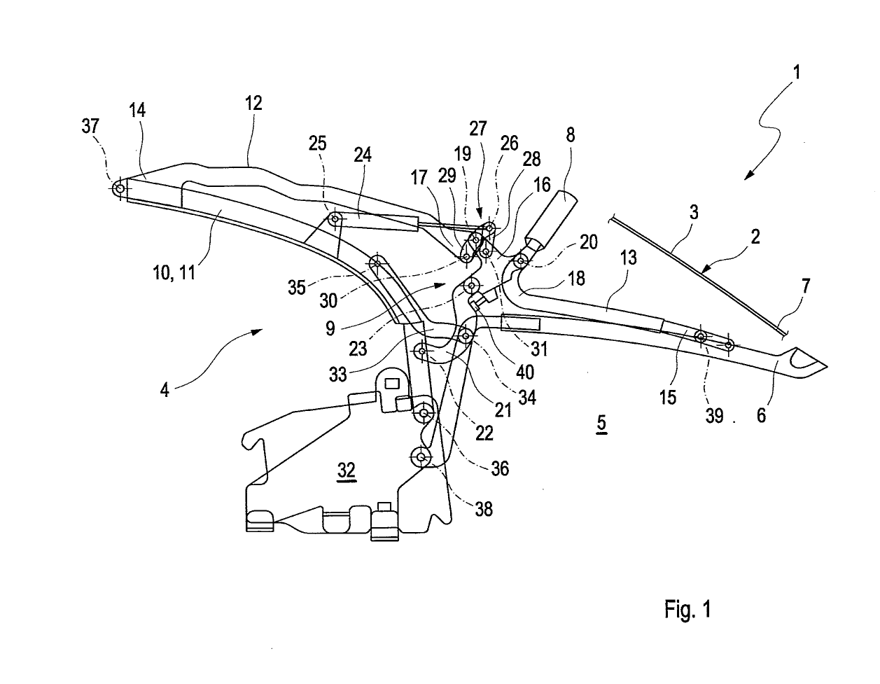

Referring now to FIGS. 1 through 5, a folding top drive assembly 4 for adjusting a folding top 2 (i.e., a collapsible roof 2) of a convertible vehicle 1 in accordance with an embodiment of the present invention will be described. Folding top 2 includes a fabric cover 3 and is movable between a closed position in which folding top 2 covers the passenger compartment of vehicle 1 and an opened position in which folding top 2 is rearwardly lowered into a storage space 5 in the rear end of vehicle 1. Folding top drive assembly 4 is configured for moving or adjusting folding top 2 between the closed and opened positions relative to the body of vehicle 1.

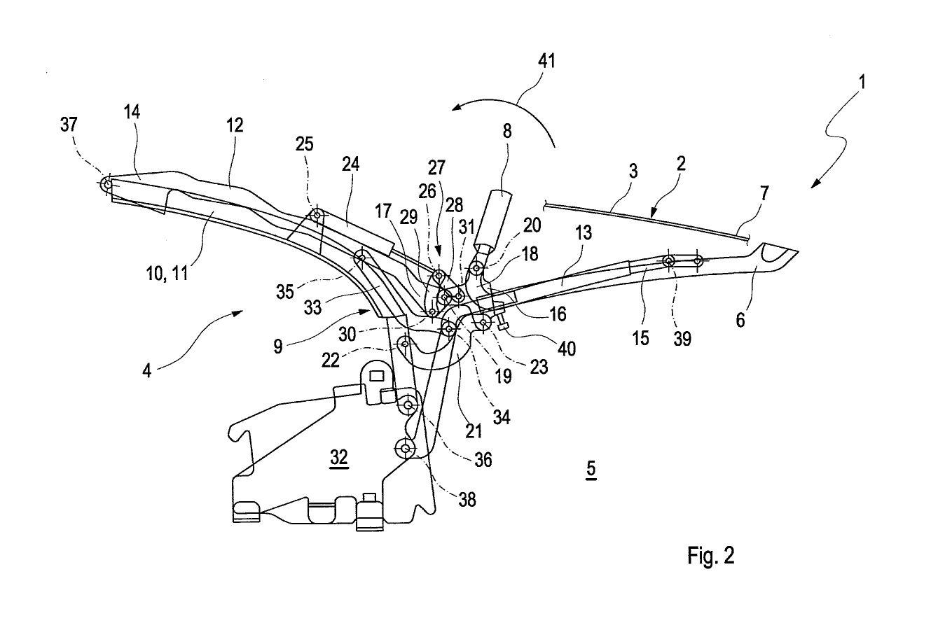

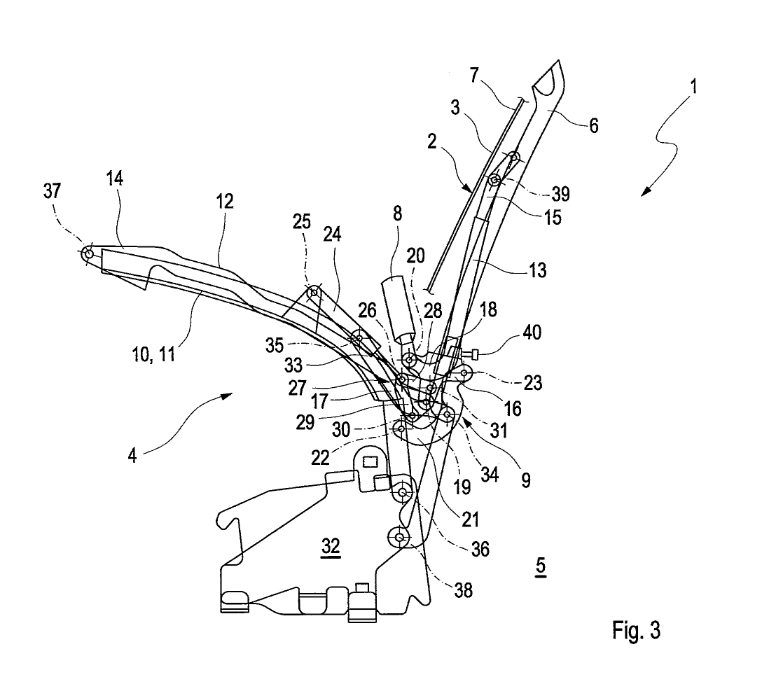

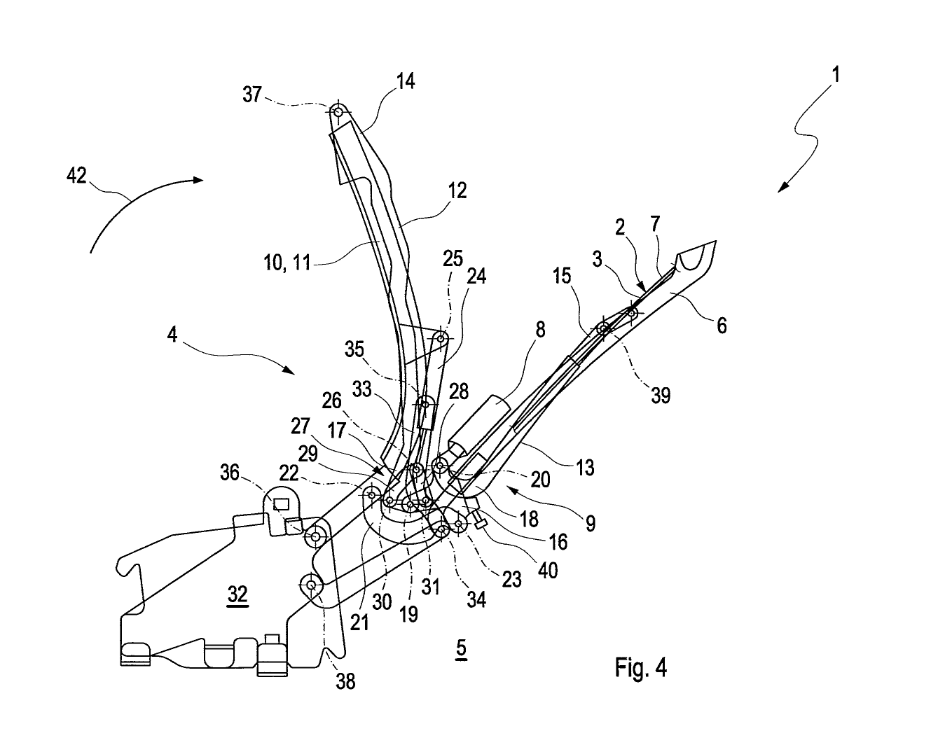

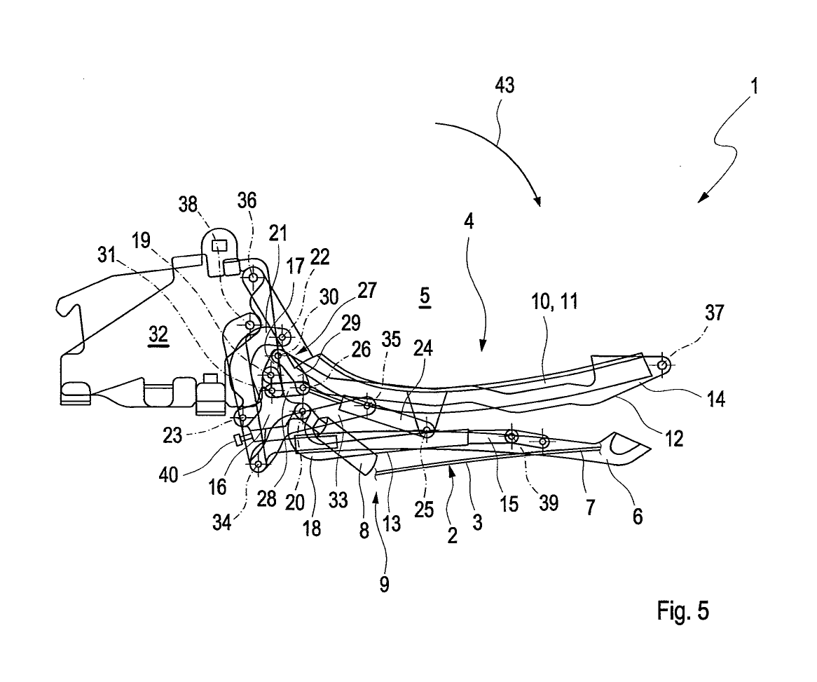

FIGS. 1 through 5 respectively illustrate side views of folding top drive assembly 4 as folding top drive assembly 4 moves folding top 2 between the closed and opened positions. In particular, in FIG. 1 folding top 2 is in the closed position; in FIG. 2 folding top 2 is in a position between the closed position and an intermediate position; in FIG. 3 folding top 2 is in the intermediate position; in FIG. 4 folding top 2 is in a position between the intermediate position and the opened position; and in FIG. 5 folding top 2 is in the opened position. As such, FIGS. 1 through 5 in sequential order illustrate folding top drive assembly 4 as folding top 2 moves from the closed position to the opened position. Conversely, FIGS. 5 through 1 in sequential order illustrate folding top drive assembly 4 as folding top 2 moves from the opened position to the closed position.

Folding top drive assembly 4 is located in a rear region of vehicle 1 in front of storage compartment 5 of vehicle 1. As indicated above, folding top 2 is lowered into and stored in storage compartment 5 (i.e., folding top bin 5) when folding top 2 is in the opened position.

Folding top drive assembly 4 includes a tensioning stay 6. Tensioning stay 6 serves to stretch fabric cover 3 of folding top 2 when folding top 2 is in the closed position (shown in FIG. 1). To this end, tensioning stay 6 is attached to a rear end 7 of fabric cover 3. Folding top drive assembly 4 further includes a corner bow 8. Corner bow 8 serves to support fabric cover 3 in the inward direction and also in the rear region in front of tensioning stay 6.

Although tensioning stay 6 and corner bow 8 extend from one side of vehicle 1 to the other, and accordingly only appear once within folding top drive assembly 4, it is conventional, for the components of folding top drive assembly 4 to be described here, that they are each present once on each side of vehicle 1, and thus appear to be present twice. In FIGS. 1 through 5, however, only the left part of folding top drive assembly 4 is visible while FIGS. 1 through 5 are understood to be external views of folding top drive assembly 4 or only the right part of folding top drive assembly 4 while FIGS. 1 through 5 are understood to be internal views of folding top drive assembly 4.

Folding top drive assembly 4 further includes at least one landau control bar mechanism 9. In an embodiment, folding top drive assembly 4 includes two landau control bar mechanisms 9 with one landau control bar mechanism on the left side of vehicle 1 and the other landau control bar mechanism on the right side of vehicle 1.

Landau control bar mechanism 9 serves to support tensioning stay 6 on a roof frame component 10 when folding top 2 is in the closed position. Tensioning stay 6 is thereby placed in a tensioned position in which it stretches fabric cover 3. In order to enable folding top 2 to move between the closed and opened positions, tensioning stay 6 makes the transition from a tensioned position shown as the stored or refracted position in FIG. 1 to an intermediate position shown as the lifted or erected position, in which fabric cover 3 is stretched. When fabric cover 3 is relaxed, folding top 2 can be moved between its closed and opened positions.

Roof frame component 10 can form a rear section of a lateral roof frame that stabilizes fabric cover 3 laterally. Roof frame component 10 can form a C-pillar when folding top is in the closed position. In the example, roof frame component 10 is formed by a main support arm 11 of folding top drive assembly 4. Main support arm 11 is movable to enable folding top drive assembly 4 to move folding top 2 between the closed and opened positions.

Landau control bar mechanism 9 includes an upper landau bar 12 and a lower landau bar 13. Upper landau bar 12 is hinged with its upper or forward end 14 on roof frame component 10. Lower landau bar 13 is hinged with its lower or rear end 15 on tensioning stay 6.

Landau control bar mechanism 9 further includes a coupling element 16. Coupling element 16 is between landau bars 12, 13. In particular, a lower or rear end 17 of upper landau bar 12 is hinged to coupling element 16. Similarly, an upper or forward end 18 of lower landau bar 13 is hinged to coupling element 16. Thus, a hinge position 19 on the side of the coupling element of upper landau bar 12 is positioned on coupling element 16 a distance away from a hinge position 20 on the side of the coupling element of lower landau bar 13.

The terms “upper”, “lower”, “forward”, and “rear” as used herein relate to a longitudinal direction of vehicle 1 moving forward in a straight line.

Landau control bar mechanism 9 further includes a seat control arm 21. Control arm 21 is hinged with its lower end 22 on roof frame component 10 and is hinged with its upper end 23 on coupling element 16. Thus, a hinge position 23 on the side of the coupling element of control arm 21 is positioned on coupling element 16 a distance away from hinge positions 19, 20 on the side of the coupling element of landau bars 12, 13. In the closed position of folding top 2 (shown in FIG. 1), hinge position 23 associated with control arm 21 is located below both of the other hinge positions 19, 20 respectively associated with landau bars 12, 13.

Folding top drive assembly 4 further includes an actuating drive or actuator 24. One end of actuator 24 is hinged at a hinge position 25 to roof frame component 10. The other end of actuator 24 is directly or indirectly hinged at a hinge position 26 to coupling element 16. Actuator 24 may be a piston-cylinder mechanism which can be operated pneumatically or hydraulically. Actuator 24 may be an electrically operable actuating drive.

In the example shown, actuator 24 is indirectly hinged to coupling element 16 via a lever mechanism 27. Lever mechanism 27 includes a first lever 28 and a second lever 29. One end of first lever 28 is mounted at a hinge position 31 to coupling element 16. The other end of first lever 28 is hinged at hinge position 26 to the other end of actuator 24. One end of second lever 29 is hinged at a hinge position 30 to lower end 17 of upper landau bar 12. The middle portion of second lever 29 is mounted at a hinge position 19 to coupling element 16 and to lower end 17 of upper landau bar 12. The other end of second lever 29 is hinged at hinge position 26 to the other end of actuator 24. Levers 28, 29 are mounted at hinge position 26 so that they can pivot with respect to one another. Thus, actuator 24 in the example is mounted at hinge position 26 formed between levers 28, 29.

Lever mechanism 27 is designed such that in the closed position of folding top 2 the hinge positions have the following locations. Hinge position 30 in which second lever 29 is mounted on upper landau bar 12 is located under hinge position 19 in which upper landau bar 12 is mounted on coupling element 16. Hinge position 31 in which first lever 28 is mounted on coupling element 16 is positioned on coupling element 16 between hinge position 19 and hinge position 20 in which lower landau bar 13 is mounted on coupling element 16. Hinge position 26 in which levers 28, 29 are mounted together is located above the two other hinge positions 30, 31 of levers 28, 29.

Corner bow 8 in the example shown is mounted so that it can pivot on coupling element 16 in the region of hinge position 20.

A main bearing mounting bracket 32 is attached rigidly to the body of vehicle 1. Thus, at least main arm 11, but here also roof frame component 10 and tensioning stay 6, are pivotably mounted on main bearing mounting bracket 32.

A connecting lever 33 is hinged at one end at a hinge position 34 to tensioning stay 6 and is hinged at its opposite end at a hinge position 35 to roof frame component 10. Hinge position 35 in which connecting lever 33 is mounted on roof frame component 10 is located in the example between a hinge position 22 in which control arm 21 is hinged on roof frame component 10 and hinge position 25 in which actuator 24 is mounted on roof frame component 10. In addition, hinge position 22 is located between hinge position 35 and a hinge position 36 in which roof frame component 10 is mounted on main bearing mounting bracket 32. Roof frame component 10 is hinged at hinge position 36 to main bearing mounting bracket 32 so that it can be pivoted.

Hinge position 25 in which actuator is mounted on roof frame component 10 is located between hinge position 35 in which connecting lever 33 is mounted on roof frame component 10 and a hinge position 37 in which upper landau bar 12 is mounted on roof frame component 10. Hinge position 34 in which connecting lever 33 is mounted on tensioning stay 6 is located between a hinge position 38 in which tensioning stay 6 is mounted on main bearing mounting bracket 32 and a hinge position 39 in which lower landau bar 13 is mounted on tensioning stay 6.

A stop 40 is formed on coupling element 16. Stop 40 comes up against control arm 21 in the closed position of folding top 2. Stop 40 defines the tensioned position of tensioning stay 6.

The manner in which folding top drive assembly 4 or its kinematic characteristics operates is explained in greater detail as follows with the aid of FIGS. 1 through 5.

As shown in the starting situation depicted in FIG. 1, folding top 2 is located in its closed position. Tensioning stay 6 is in its tensioned position so that fabric cover 3 of folding top 2 is stretched. Stop 40 abuts against control arm 21.

Fabric cover 3 has to be loosened in order for folding top 2 to be movable towards its opened position. As such, tensioning stay 6 has to be moved from its tensioned position shown in FIG. 1 into its lifted intermediate position shown in FIG. 3.

Actuator is accordingly activated according to FIG. 2 so that the interval between hinge position 25 on the roof frame component side of actuator 24 and hinge position 26 on the coupling part side of actuator 24 is reduced. In this manner, coupling element 16 is rotated about a transverse axis, shown in FIG. 2 by an arrow 41, in the counter clockwise direction. This reduces an interval between hinge position 37 in which upper landau bar 12 is hinged at roof frame component 10 and hinge position 39 in which lower landau bar 13 is hinged to tensioning stay 6. Since during this part of the opening process roof frame component 10 is not moved, tensioning stay 6 is caused to lift by the rotational motion of coupling element 16. FIG. 2 thus shows a position of tensioning stay 6 that lies between its tensioned position shown in FIG. 1 and its completely lifted intermediate position shown in FIG. 3.

Folding top 2 only starts to be refracted after tensioning stay 6 has attained its intermediate position shown in FIG. 3. To do this, main arm 11, and thus roof frame component 10, is tilted upwardly according to arrow 42 on FIG. 4 and is tilted inwardly according to arrow 43 on FIG. 5 into folding top bin 5. When folding top 2 is in its opened position, main arm 11 first recovers corner bow 8 and then also tensioning stay 6. This results in a relatively compact folded opened position for folding top 2 in FIG. 5.

As required, detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. An assembly for moving a folding top having a fabric cover between a closed position and an opened position, the assembly comprising:
a tensioning stay attachable to the fabric cover of the folding top;
a landau control bar mechanism having an upper landau bar, a lower landau bar, and a coupling element and configured to support the tensioning stay on a roof frame component when the folding top is in the closed position to enable the tensioning stay to stretch the fabric cover when the folding top is in the closed position;
wherein the upper landau bar is hinged at a forward end on the roof frame component and the lower landau bar is hinged at a rearward end on the tensioning stay;
wherein the upper landau bar is hinged at a rearward end on the coupling element and the lower landau bar is hinged at a forward end on the coupling element, wherein the rearward end of the upper landau bar and the forward end of the lower landau bar are hinged on the coupling element at a distance from one another.

2. The assembly of claim 1 wherein:
the coupling element pivots such that distance between a hinge position of the forward end of the upper landau bar and the roof frame component and a hinge position of the rearward end of the lower landau bar and the tensioning stay increases as the tensioning stay moves into a tensioned position stretching the fabric cover when the folding top moves into the closed position.

3. The assembly of claim 1 further comprising:
a control arm hinged at a forward end on the roof frame component and hinged at a rearward end on the coupling element, wherein the rearward end of the upper landau bar, the forward end of the lower landau bar, and the rearward end of the control arm are hinged on the coupling element at a distance from one another.

4. The assembly of claim 3 further comprising:
an actuator, wherein the actuator is hinged at one end on the roof frame component.

5. The assembly of claim 4 further comprising:
a lever mechanism having a first lever and a second lever, wherein the first lever is hinged on the coupling element and the second lever is hinged on the rearward end of the upper landau bar;
wherein the first lever is hinged on the other end of the actuator and the second lever is hinged on the other end of the actuator such that the actuator is hinged indirectly at the other end on the coupling element via the lever mechanism.

6. The assembly of claim 5 wherein:
in the closed position of the folding top, the hinge position between the second lever and the rearward end of the upper landau bar is located below the hinge position between the rearward end of the upper landau bar and the coupling element.

7. The assembly of claim 5 wherein:
in the closed position of the folding top, the hinge position between the first lever and the coupling element is located between the hinge position between the rearward end of the upper landau bar and the coupling element and the hinge position between the forward end of the lower landau bar and the coupling element.

8. The assembly of claim 5 further comprising:
a corner bow, wherein the corner bow is hinged on the coupling element in a region of the hinge position between the forward end of the lower landau bar and the coupling element.

9. The assembly of claim 5 further comprising:
a main bearing mounting bracket rigidly connectable to vehicle body, wherein the main bearing mounting bracket is hinged to the roof frame component and the tensioning stay.

10. The assembly of claim 9 further comprising:
a connecting lever hinged at one end on the tensioning stay and hinged at another end on the roof frame component.

11. The assembly of claim 10 wherein:
the hinge position between the control arm and the roof frame component is between the hinge position between the connecting lever and the roof frame component and the hinge position between the roof frame component and the main bearing mounting bracket.

12. The assembly of claim 10 wherein:
the hinge position between the roof frame component and the end of the actuator is between the hinge position between the forward end of the upper landau bar and the roof frame component and the hinge position between the connecting lever and the roof frame component.

13. The assembly of claim 10 wherein:
the hinge position between the roof frame component and the connecting lever is between the hinge position between the end of the actuator and the roof frame component and the hinge position between the control arm and the roof frame component.

14. A vehicle comprising:
a folding top having a fabric cover; and
a folding top drive assembly configured to move the folding top between a closed position in which the folding top covers a passenger compartment of the vehicle and an opened position in which the folding top is stored in a storage compartment of the vehicle;
wherein the folding top drive assembly includes a tensioning stay attached to the fabric cover of the folding top;
wherein the folding top drive assembly further includes a landau control bar mechanism configured to support the tensioning stay on a roof frame component when the folding top is in the closed position to enable the tensioning stay to stretch the fabric cover when the folding top is in the closed position;
wherein the landau control bar mechanism includes an upper landau bar, a lower landau bar, and a coupling element, wherein the upper landau bar is hinged at a forward end on the roof frame component and the lower landau bar is hinged at a rearward end on the tensioning stay;
wherein the upper landau bar is hinged at a rearward end on the coupling element and the lower landau bar is hinged at a forward end on the coupling element, wherein the rearward end of the upper landau bar and the forward end of the lower landau bar are hinged on the coupling element at a distance from one another.

15. The vehicle of claim 14 wherein:
the coupling element pivots such that distance between a hinge position of the forward end of the upper landau bar and the roof frame component and a hinge position of the rearward end of the lower landau bar and the tensioning stay increases as the tensioning stay moves into a tensioned position stretching the fabric cover when the folding top moves into the closed position.

16. The vehicle of claim 14 wherein:
the folding top drive assembly further includes a control arm hinged at a forward end on the roof frame component and hinged at a rearward end on the coupling element, wherein the rearward end of the upper landau bar, the forward end of the lower landau bar, and the rearward end of the control arm are hinged on the coupling element at a distance from one another.

17. The vehicle of claim 16 wherein:
the folding top drive assembly further includes an actuator, wherein the actuator is hinged at one end on the roof frame component.

18. The vehicle of claim 17 wherein:
the folding top drive assembly further includes a lever mechanism having a first lever and a second lever, wherein the first lever is hinged on the coupling element and the second lever is hinged on the rearward end of the upper landau bar;
wherein the first lever is hinged on the other end of the actuator and the second lever is hinged on the other end of the actuator such that the actuator is hinged indirectly at the other end on the coupling element via the lever mechanism.

19. The vehicle of claim 18 further comprising:
a corner bow, wherein the corner bow is hinged on the coupling element in a region of the hinge position between the forward end of the lower landau bar and the coupling element.

20. The vehicle of claim 14 further comprising:
a main bearing mounting bracket rigidly connected to vehicle body, wherein the main bearing mounting bracket is hinged to the roof frame component and the tensioning stay.
